(19) United States
(12) Patent Application Publication
(10) Pub. No.: US 2025/0333064 A1
(43) Pub. Date: Oct. 30, 2025

(54) ACOUSTIC SENSOR AND VEHICLE STRUCTURE

(71) Applicants: J-QuAD DYNAMICS Inc., Tokyo (JP); DENSO CORPORATION, Kariya-city (JP)

(72) Inventors: Yuka SATRE, Tokyo (JP); Yoshihiro HIROHASHI, Kariya-city (JP); Ryoma NIIHARA, Kariya-city (JP); Kazuki IZUMI, Kariya-city (JP); Shiori MANEYAMA, Kariya-city (JP)

(21) Appl. No.: 19/073,207

(22) Filed: Mar. 7, 2025

(30) Foreign Application Priority Data
Apr. 26, 2024 (JP) 2024-072120

(51) Int. Cl. B60W 40/06

(52) U.S. Cl. CPC B60W 40/06; B60W 2400/00; B60W 2420/10; B60W 2422/70

(57) ABSTRACT

An acoustic sensor is configured to be attached to a cover member covering an outer circumferential portion of a tire of a vehicle and measure information related to sound vibrations. The acoustic sensor includes a sensor support, a facing surface, and a vibration detector. The sensor support is attached to a cover outer surface of the cover member. The cover member has a curved plate portion extending in a circumferential direction of the tire. The cover outer surface is one surface of the curved plate portion that faces away from the tire. The facing surface faces the cover outer surface to receive the sound vibrations of the cover outer surface when the sensor support is attached to the cover outer surface. The vibration detector is configured to detect the sound vibrations that are received by the facing surface.

### CROSS REFERENCE TO RELATED APPLICATION

The present application claims the benefit of priority from Japanese Patent Application No. 2024-072120 filed on Apr. 26, 2024. The entire disclosure of the above application is incorporated herein by reference.

### TECHNICAL FIELD

This disclosure relates to an acoustic sensor and a vehicle structure that includes an acoustic sensor.

### BACKGROUND

There is a road surface condition detection device equipped with a microphone.

### SUMMARY

One disclosed aspect is an acoustic sensor configured to be attached to a cover member covering an outer circumferential portion of a tire of a vehicle and configured to measure information related to sound vibrations. The acoustic sensor includes a sensor support, a facing surface, and a vibration detector. The sensor support is configured to be attached to a cover outer surface of the cover member. The cover member has a curved plate portion extending in a circumferential direction of the tire. The cover outer surface is one surface of the curved plate portion that faces away from the tire. The facing surface is configured to face the cover outer surface to receive the sound vibrations of the cover outer surface when the sensor support is attached to the cover outer surface. The vibration detector is configured to detect the sound vibrations that are received by the facing surface.

Another disclosed aspect is a vehicle structure having a cover member and an acoustic sensor. The cover member has a curved plate portion extending in a circumferential direction of a tire of a vehicle and configured to cover an outer circumferential portion of the tire. The acoustic sensor is attached to the cover member and configured to measure information related to sound vibrations. The acoustic sensor includes a sensor support, a facing surface, and a vibration detector. The sensor support is attached to a cover outer surface that is one surface of the curved plate portion facing away from the tire. The facing surface faces the cover outer surface to receive the sound vibrations of the cover outer surface when the sensor support is attached to the cover outer surface. The vibration detector is configured to detect the sound vibrations that are received by the facing surface.

### BRIEF DESCRIPTION OF THE DRAWINGS

FIG. 1 is a diagram showing a vehicle structure of a first embodiment in which an acoustic sensor according to the first embodiment is mounted on a vehicle.

FIG. 2 is a diagram showing an acoustic sensor according to a comparative example.

FIG. 3 is a diagram for explaining the effect of an invisibly arranged acoustic sensor.

FIG. 4 is a diagram for explaining the effect of an acoustic sensor disposed forward of the tire, showing a scene in which water on the road surface is shallow.

FIG. 5 is a diagram for explaining the effect of the acoustic sensor disposed forward of the tire, showing a scene where water on the road surface is deep.

FIG. 6 is a diagram showing a vehicle structure of a second embodiment in which an acoustic sensor of the second embodiment is mounted on a vehicle.

FIG. 7 is a diagram showing a vehicle structure of a third embodiment in which an acoustic sensor of the third embodiment is mounted on a vehicle.

FIG. 8 is a diagram showing a vehicle structure of a fourth embodiment in which an acoustic sensor of the fourth embodiment is mounted on a vehicle.

### DESCRIPTION OF EMBODIMENTS

To begin with, examples of relevant techniques will be described.

There is a road surface condition detection device equipped with a microphone. The microphone is mounted on the vehicle at a position forward of the tire.

The microphone located forward of the tire is designed to collect sounds in the surrounding space. Thus, it is difficult to effectively collect sound vibrations generated near the tire. In addition, other sound vibrations generated at positions far from the tire may be transmitted to the microphone. These factors make it challenging to improve the accuracy of detecting sound vibrations generated near the tire.

The present disclosure provides an acoustic sensor that can improve the accuracy of detecting sound vibrations generated near a tire, and a vehicle structure including the acoustic sensor.

One disclosed aspect is an acoustic sensor configured to be attached to a cover member covering an outer circumferential portion of a tire of a vehicle and configured to measure information related to sound vibrations. The acoustic sensor includes a sensor support, a facing surface, and a vibration detector. The sensor support is configured to be attached to a cover outer surface of the cover member. The cover member has a curved plate portion extending in a circumferential direction of the tire. The cover outer surface is one surface of the curved plate portion that faces away from the tire. The facing surface is configured to face the cover outer surface to receive the sound vibrations of the cover outer surface when the sensor support is attached to the cover outer surface. The vibration detector is configured to detect the sound vibrations that are received by the facing surface.

Another disclosed aspect is a vehicle structure having a cover member and an acoustic sensor. The cover member has a curved plate portion extending in a circumferential direction of a tire of a vehicle and configured to cover an outer circumferential portion of the tire. The acoustic sensor is attached to the cover member and configured to measure information related to sound vibrations. The acoustic sensor includes a sensor support, a facing surface, and a vibration detector. The sensor support is attached to a cover outer surface that is one surface of the curved plate portion facing away from the tire. The facing surface faces the cover outer surface to receive the sound vibrations of the cover outer surface when the sensor support is attached to the cover outer surface. The vibration detector is configured to detect the sound vibrations that are received by the facing surface.

In these embodiments, the acoustic sensor is attached to the cover member that covers the outer circumferential portion of the tire, with the facing surface facing the curved plate portion that extends in the circumferential direction of the tire. Thus, the facing surface can effectively collect sound vibrations generated near the tire using the curved surface portion shaped to cover the tire. In addition, since the facing surface faces the tire, other sound vibrations generated far from the tire are less likely to be transmitted to the facing surface. As a result, it is possible to improve the accuracy of detecting sound vibrations generated near the tire.

Combinations of claims that are not explicitly stated in claims by dependency are also included in a scope of the present disclosure unless there is a particular difficulty existing in the combination.

Hereinafter, a plurality of embodiments will be described with reference to the drawings. Incidentally, the same reference numerals are assigned to the corresponding components in each embodiment, and thus, duplicate descriptions may be omitted. In each of the embodiments, when only a part of the configuration is described, the remaining parts of the configuration may adopt corresponding parts of other embodiments. Further, not only the combinations of the configurations explicitly shown in the description of the respective embodiments, but also the configurations of multiple embodiments can be partially combined even when they are not explicitly shown as long as there is no difficulty in the combination in particular.

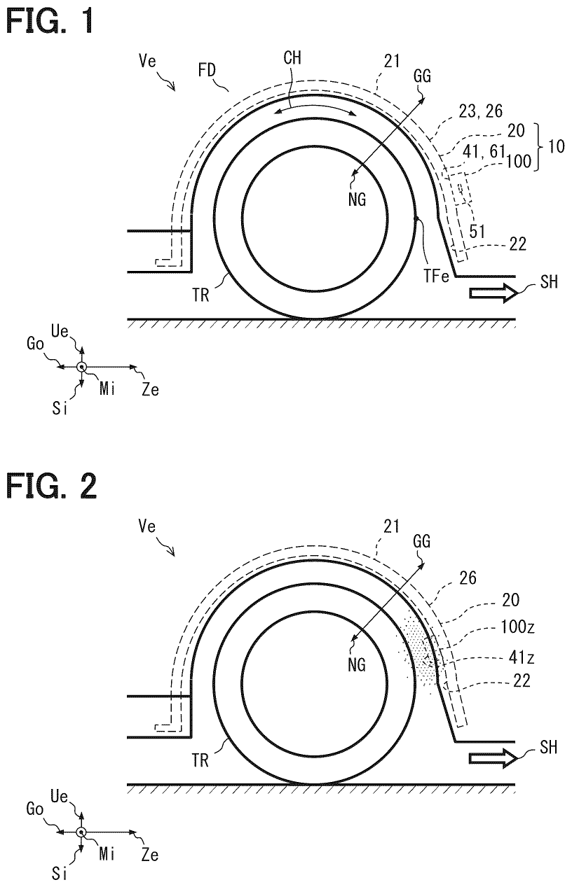

(First Embodiment) An acoustic sensor 100 according to a first embodiment of the present disclosure is disposed near a tire TR of a vehicle Ve shown in FIG. 1. The acoustic sensor 100 measures information related to sound vibrations generated near the tire TR as the vehicle Ve travels. The acoustic sensor 100 is attached to a wheel well cover 20 that covers the tire TR. The acoustic sensor 100 and the wheel well cover 20 constitute a vehicle structure 10 that is mounted on the vehicle Ve.

The configuration of the acoustic sensor 100, the installation of the acoustic sensor 100, and the signal processing ECU that processes detection signals of the acoustic sensor 100 will be described in detail below with reference to FIG. 1.

Here, the front-rear direction and the left-right direction are defined with reference to the vehicle Ve stationary on the horizontal plane. Specifically, the front-rear direction (the forward direction Ze and the reverse direction Go) is defined along the longitudinal direction of the vehicle Ve. The forward direction Ze corresponds to the traveling direction SH of the vehicle Ve. The right-left direction (the right direction Mi and the left direction) is defined along the width direction of the vehicle Ve. Further, a vertical direction (the up direction Ue and the down direction Si) is defined along a direction vertical to the horizontal plane that defines the front-rear direction and the right-left direction. Furthermore, a circumferential direction CH, an inner circumferential direction NG, and an outer circumferential direction GG are defined with respect to one tire TR. For simplifying the description, the description of the reference numerals indicating each direction may be omitted as appropriate in the following description.

(Details of Acoustic Sensor Configuration) The acoustic sensor 100 includes a sensor housing 40, a circuit board, a sound vibration sensor 51, and a retainer.

The sensor housing 40 has a flat rectangular prism or cylindrical shape as a whole. The sensor housing 40 is mainly made of a resin material. The sensor housing 40 defines an inner space therein and houses the circuit board and the sound vibration sensor 51 in the inner space.

The sensor housing 40 has a sound collecting surface 41. The sound collecting surface 41 is formed by the bottom wall of the sensor housing 40. The sound collecting surface 41 is at least a part of the outer surface of the bottom wall, which is flat. The sound collecting surface 41 captures sound vibrations to be measured by the sound vibration sensor 51.

The circuit board is a glass epoxy board or the like, and has a rectangular plate shape as a whole. The circuit board is housed in the sensor housing 40 to be aligned with the sound collecting surface 41. The circuit board is provided with an amplifier circuit, a communication interface, and the like. The amplifier circuit is electrically connected to the sound vibration sensor 51 and amplifies detection signals output by the sound vibration sensor 51. The communication interface outputs the detection signals amplified by the amplifier circuit.

The sound vibration sensor 51 is a microphone element that converts air vibrations such as sound into electric signals. The sound vibration sensor 51 is, for example, a condenser microphone mainly composed of a Micro Electro Mechanical Systems (MEMS) microphone. The sound vibration sensor 51 converts a change in capacitance that occurs when sound pressure vibrates a thin vibrating membrane into an electric signal, and outputs the electric signal as a detection signal. The sound vibration sensor 51 is mounted on the circuit board, and detects sound vibrations that are collected by the sound collecting surface 41 and transmitted to the thin vibrating membrane. The detection signal from the sound vibration sensor 51 is output to an external component such as the signal processing ECU through a wire harness or the like.

The sound vibration sensor 51 may include a piezoelectric sensor as a microphone element instead of the MEMS microphone. A piezoelectric sensor measures the vibration of a metal vibrating membrane using a piezoelectric element formed in a thin plate shape. Furthermore, the sound vibration sensor 51 may include an electret condenser microphone as a microphone element instead of the MEMS microphone. In addition, the circuit board may further include a signal processing circuit for processing the detection signal of the sound vibration sensor 51. The signal processing circuit is mainly composed of a microcontroller. In such a configuration, the processing results generated by the signal processing circuit are output to an external in-vehicle ECU or the like via a wire harness or the like.

The retainer is made of a resin material and has a flat cylindrical shape with a flange. The retainer holds the sensor housing 40 against the wheel well cover 20. The retainer has a sensor support 61. The sensor support 61 is a flange provided on the retainer. The sensor support 61 is attached to the wheel well cover 20 with an adhesive layer so that the sensor support 61 is held by the wheel well cover 20. The adhesive layer is made of a double-sided tape or an adhesive material.

(Details of Acoustic Sensor Installation) The acoustic sensor 100 is mounted on the vehicle Ve with being assembled to the wheel well cover 20. The wheel well cover 20 is formed from a lightweight and highly durable material such as polyethylene resin and hard fibers made of polyester fibers mixed with hard styrene-butadiene rubber. The wheel well cover 20 is a molded product having a curved plate shape as a whole.

The wheel well cover 20 is disposed on the outer circumferential side of the tire TR and inside the fender FD as a fender liner. The wheel well cover 20 is attached to the vehicle Ve to fill the gap between the fender FD and the tire TR. The wheel well cover 20 prevents mud, splashes, and the like stirred up from the road surface by the tire TR from entering the vehicle body, thereby reducing corrosion and damage to the vehicle structure. The wheel well cover 20 absorbs noise and vibrations generated when the vehicle Ve is traveling, improving the quietness in a vehicle cabin.

The wheel well cover 20 includes a cover body 21. The cover body 21 is a body of the wheel well cover 20. The cover body 21 has a curved plate shape extending in the circumferential direction CH of the tire TR. The radius of curvature of the cover body 21 that is curved in an arch shape is larger than the radius of the tire TR as a whole. The cover body 21 has two opposite surfaces which is a cover inner surface 22 and a cover outer surface 23.

The cover inner surface 22 is one plate surface facing in the inner circumferential direction NG. The cover inner surface 22 is an exposed surface (i.e., front surface) that is exposed to a wheel well when the wheel well cover 20 is attached to the vehicle Ve. The cover inner surface 22 faces the tread surface of the tire TR in the radial direction. The cover inner surface 22 may be equipped with a sound absorbing material such as felt to improve noise reduction.

The cover outer surface 23 is the other plate surface facing in the outer circumferential direction GG. When the wheel well cover 20 is attached to the vehicle Ve, the cover outer surface 23 is a back surface facing the inside of the vehicle body. The cover outer surface 23 is not exposed to the space around the tire TR. The acoustic sensor 100 is attached to the cover outer surface 23. The cover outer surface 23 is fitted with a guide.

The guide protrudes from the cover outer surface 23 in the outer circumferential direction GG (i.e., away from the tire TR). The guide extends along the outer edge of the sensor support 61 and is used to position the acoustic sensor 100. The cover body 21 has a front portion 26, and the guide is formed on the cover outer surface 23 of the front portion 26. The front portion 26 is a portion of the cover body 21 located forward of the tire TR in the forward direction Ze (i.e., the traveling direction SH). The front portion 26 is a portion of the cover body 21 that is located forward of the front end TFe of the tread surface of the tire TR. The shape of the guide may be changed as appropriate as long as the guide can position the acoustic sensor 100. The guide may be formed in a pin shape. Alternatively, a recess corresponding to the shape of the acoustic sensor 100 may be formed in the cover outer surface 23 as a guide. The cover outer surface 23 is not necessarily provided with the guide.

The acoustic sensor 100 is installed near one of the left and right front tires of the vehicle Ve. The acoustic sensor 100 may be provided near each of the left front tire and the right front tire. The acoustic sensor 100 is mounted on the vehicle Ve in an invisible arrangement in which the acoustic sensor 100 is not visible from the outside of the vehicle Ve. The acoustic sensor 100 is installed forward of the tire TR with the sound collecting surface 41 facing the tire TR (i.e., in the inner circumference direction NG) to more effectively measure water pushing sound generated at the front portion of the tire TR than the water splashing sound generated at the rear portion of the tire TR.

More specifically, the sensor support 61 is held by the cover outer surface 23 of the cover body 21 that faces in the outer circumferential direction GG. The sensor support 61 is attached to the cover outer surface 23 of the front portion 26 of the cover body 21 with facing in the inner circumferential direction NG. The sensor support 61 is attached to the cover outer surface 23 with an adhesive layer while being positioned by the guide. The sound collecting surface 41 faces the cover outer surface 23 to receive sound vibrations of the cover outer surface 23 when the sensor support 61 is held by the cover outer surface 23. The sound collecting surface 41 is held on the cover outer surface 23 via an adhesive layer, similar to the sensor support 61. The sound collecting surface 41 is in indirect contact with the cover outer surface 23. This allows the vibration of the cover body 21 to be efficiently transmitted to the sound collecting surface 41.

The state in which the sound collecting surface 41 is in indirectly contact with the cover outer surface 23 means a state in which the sound collecting surface 41 and the cover outer surface 23 are in contact respectively with both surfaces of a solid vibration transmission member without defining spaces between the sound collecting surface 41 and the cover outer surface 23. The adhesive layer between the sound collecting surface 41 and the cover outer surface 23 may be omitted. The sound collecting surface 41 in this form is pressed against the cover outer surface 23 and comes into direct contact with the cover outer surface 23, not indirectly.

Furthermore, the acoustic sensor 100 does not need to include the retainer or its equivalent. In the acoustic sensor 100, the sound collecting surface 41 also serves as the sensor support 61. That is, the sound collecting surface 41 and the sensor support 61 may be integrally formed by the bottom wall of the housing body.

(Details of Signal Processing ECU) The signal processing ECU is a calculation device installed in the vehicle Ve. The signal processing ECU is electrically connected to the acoustic sensor 100 via a wire harness or the like. The signal processing ECU serves as a signal processing device that processes detection signals output by the acoustic sensor 100. When the vehicle Ve includes multiple acoustic sensors 100, the signal processing ECU acquires detection signals from the acoustic sensors 100 and processes the acquired detection signals. The signal processing ECU may be an in-vehicle ECU dedicated to acoustic recognition that processes detection signals of the acoustic sensor 100, or may be an in-vehicle ECU dedicated to environmental recognition that recognizes the driving environment around the vehicle. Furthermore, the signal processing ECU may be an Advanced Driver-Assistance Systems (ADAS)-ECU capable of implementing driving assistance control, or an autonomous driving ECU capable of implementing autonomous driving control.

The signal processing ECU recognizes the condition of the road surface on which the vehicle Ve is traveling based on detection signals of the acoustic sensor 100. Specifically, the signal processing ECU determines whether the road surface on which the vehicle Ve is traveling is wet or not. Furthermore, when the signal processing ECU determines that the vehicle Ve is traveling on a wet road surface, the signal processing ECU estimates the amount of water accumulated on the road surface on which the vehicle is traveling, in other words, the road surface water level.

The signal processing ECU may be capable of executing a process of detecting siren sounds of an emergency vehicle approaching the vehicle Ve, in addition to the process of recognizing the road surface condition. Here, in the configuration in which the detection signal of the acoustic sensor 100 mounted on the wheel well cover 20 is used, the timing for detecting siren sounds of an approaching emergency vehicle is delayed compared to the configuration in which the detection signal of an acoustic sensor that is arranged on the rear window is used. However, even when the detection signal of the acoustic sensor 100 mounted on the wheel well cover 20 is used, the signal processing ECU can detect siren sounds of an approaching emergency vehicle with a certain degree of distance and time leeway. In addition, the signal processing ECU may further be configured to execute a process for detecting an impact sound generated on the vehicle Ve. The impact sound may be a sound generated when a parked vehicle Ve is tampered with or something hits the parked vehicle Ve. The impact sound detection process can be used as a means for monitoring a parked vehicle Ve.

(Effects of Invisible and Forward Placement of Acoustic Sensor) The acoustic sensor 100 described so far is invisibly placed forward of the tire TR in the forward direction Ze. The effect of this configuration in improving the accuracy of estimating the road surface water level by the signal processing ECU will be described in detail below.

(Effects of Invisible Placement) An acoustic sensor 100z of a comparative example shown in FIG. 2 is attached to the cover inner surface 22 of the cover body 21 with the sound collecting surface 41z facing the tire TR. The acoustic sensor 100z collects sound vibrations in the space around the sensor mainly through a sound collecting surface 41z. It is difficult to distinguish between sounds caused by water accumulating on the road surface (such as splashing sounds) and sounds caused by sand or other materials on the road surface (such as sounds of sand and pebbles hitting the vehicle body) when the detection signal (i.e., audio data) output by the visibly placed acoustic sensor 100z is used. That is, it is difficult to distinguish between the sounds of water and the sounds of sand based on the audio data, and the signal processing ECU cannot accurately determine whether there is water on the road surface, in other words, whether the road surface is wet or not.

It is also assumed that the acoustic sensor 100z is attached to the cover inner surface 22 with the sound collecting surface 41z facing the cover inner surface 22. In the acoustic sensor 100z mounted in this manner, the sound collecting surface 41z faces away from the tire TR. Thus, the sound collecting surface 41z easily collects other sound vibrations arriving at the acoustic sensor 100z from areas away from the tire TR, specifically, noise generated by a power source such as an engine and noise generated inside the vehicle cabin. This makes it difficult for the signal processing ECU to detect sound vibrations generated near the tire TR since other sound vibrations interfere with the signal processing ECU.

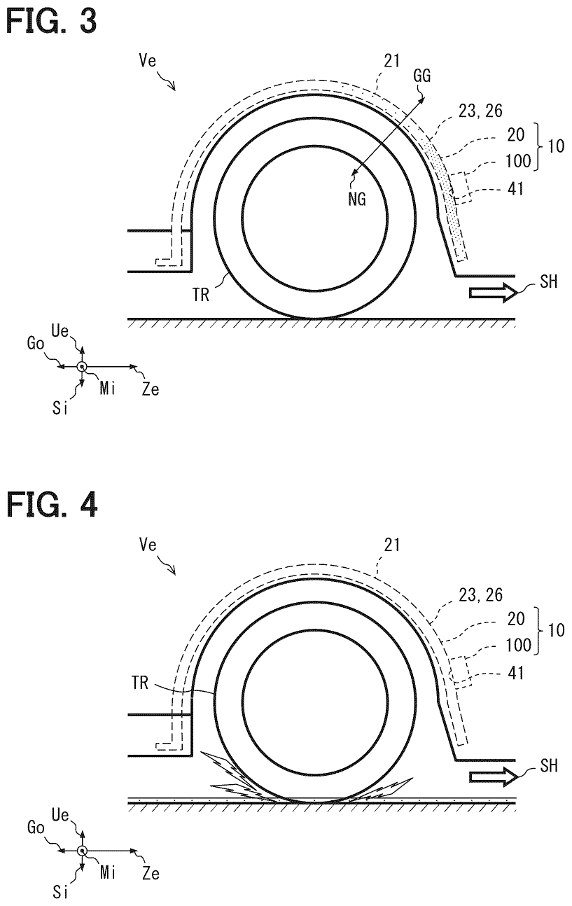

In contrast, the acoustic sensor 100 shown in FIG. 3 is attached to the cover outer surface 23 of the cover body 21 with the sound collecting surface 41 facing the tire TR. The acoustic sensor 100, which is built in the wheel well cover 20, uses the wheel well cover 20 to collect sound vibrations generated near the tire TR. The wheel well cover 20 covers the front portion, the upper portion, and the rear portion of the tire TR from the outer circumferential side of the tire TR. Due to this shape, the area of the wheel well cover 20 is larger than the area of the sound collecting surface 41. Thus, the sound collecting surface 41 can effectively collect sound vibrations generated near the tire TR by using the wheel well cover 20 that covers the outer circumferential portion of the tire TR.

In addition, the sound collecting surface 41 faces the tire TR, so that the sound collecting surface 41 is less likely to collect other sound vibrations arriving at the acoustic sensor 100 from areas away from the tire TR. Thus, the sound collecting surface 41 can collect sound vibrations generated near the tire TR in preference to other sound vibrations. As a result of the above, the amount of information on sound vibrations near the tire collected by the sound collecting surface 41 increases, thereby improving the S/N ratio. As a result, the signal processing ECU can easily distinguish between the sound of water and the sound of sand, and can accurately determine whether the road surface is wet.

Furthermore, the vehicle structure 10 in which the acoustic sensor 100 is invisibly arranged can prevent water that accumulates on the road surface from directly hitting the acoustic sensor 100. Thus, design requirements related to waterproofness and water-submersion resistance of the acoustic sensor 100 can be relaxed compared to the acoustic sensor 100z (see FIG. 2) that is used in a visible placement.

Furthermore, even when the vehicle Ve is traveling on a snowy road, ice does not adhere to the invisibly arranged acoustic sensor 100. Thus, the deterioration of the acoustic sensor 100 caused by the adhesion of ice can be reduced.

In addition, the detection signal of the invisibly arranged acoustic sensor 100 is less likely to include wind noise. Thus, the acoustic sensor 100 can effectively measure the sound of water without being interfered by the sound of wind.

The invisible placement of the acoustic sensor 100 may require more consideration for differences due to vehicle types compared to the visible placement (see FIG. 2). However, the frequency band of the sound of water is about 5 to 10 KHz, while the natural frequency of the vibration caused by the vehicle body and tires TR is in a lower frequency band of about 300 to 800 Hz. Thus, by taking into consideration the frequency band used for recognition, it is possible to accurately detect the sound of water while reducing the influence of differences due to vehicle type.

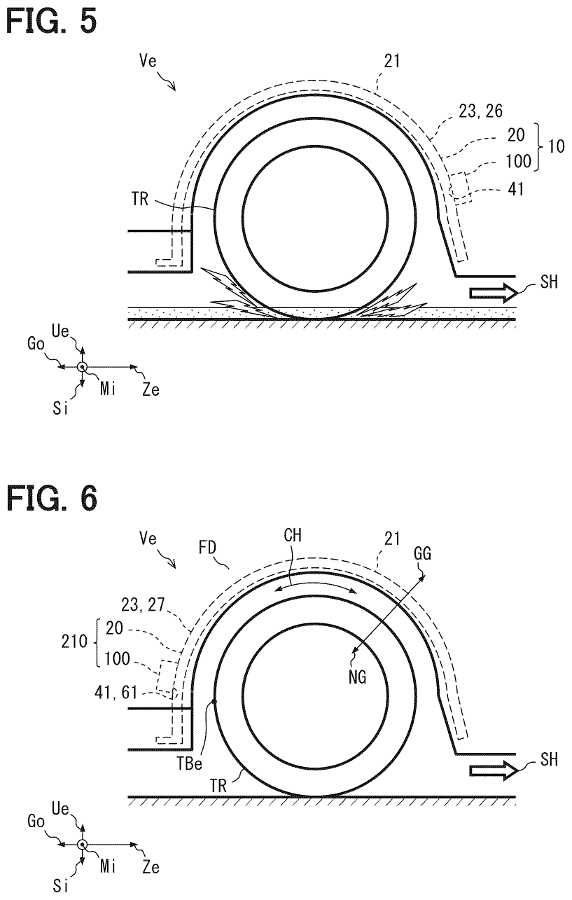

(Effects of Forward Placement) FIG. 4 and FIG. 5 show the driving situations where the water levels on the road on which the vehicle Ve is traveling are different. In a driving situation where water has accumulated on the road surface, the sound of water generated behind the tire TR is mainly the sound of the tire TR splashing water. On the other hand, the sound of water generated in front of the tire TR is mainly the sound of the tire TR pushing out water.

When the depth of water accumulated on the road surface exceeds a predetermined value (for example, about 1 cm), the splashing noise is unlikely to change, even when the water level changes. This is presumably because, due to an upper limit of the drainage performance of the tire TR, the amount of water splashed downstream of the tire TR does not substantially change when the water depth exceeds the predetermined value. On the other hand, the pushing sound changes according to the depth of the water, even in an area where the depth of the water accumulated on the road surface exceeds the predetermined value. This is presumably because the amount of water pushed out by the tire TR on the upstream side of the tire TR changes continuously as the water depth increases, without being affected by the drainage performance of the tire TR.

As described above, the acoustic sensor 100 disposed forward of the tire TR mainly detects pushing sounds rather than splashing sounds as sound vibrations. As a result, the signal processing ECU can more accurately estimate the depth of water accumulated on the road surface (water volume, water level, etc.) when the vehicle Ve is traveling on a wet road surface.

In addition, when the vehicle Ve travels on a snowy road, ices are less likely to adhere to a portion of the cover inner surface 22 located forward of the tire TR Ze than to a portion of the cover inner surface 22 located rearward of the tire TR. Thus, the effect of ice adhering to the cover inner surface 22, which attenuate sound vibrations, is minimal for the acoustic sensor 100 located forward of the tire TR.

(Summary of First Embodiment) In the first embodiment described so far, the acoustic sensor 100 is attached to the wheel well cover 20 with the sound collecting surface 41 facing the cover body 21. The wheel well cover 20 covers the outer circumferential portion of the tire TR, and the cover body 21 of the wheel well cover 20 extends in the circumferential direction CH of the tire TR. Thus, the sound collecting surface 41 can effectively collect sound vibrations generated near the tire TR by utilizing the cover body 21 shaped to cover the tire TR. In addition, since the sound collecting surface 41 faces the tire TR, other sound vibrations generated far from the tire TR are less likely to be transmitted to the sound collecting surface 41. Thus, the accuracy of detecting sound vibrations generated near the tire TR can be improved.

In addition, the sound collecting surface 41 in the first embodiment is in indirect contact with the cover outer surface 23 with the sensor support 61 being held on the cover outer surface 23. Thus, sound vibrations of the cover body 21 can be efficiently transmitted to the sound collecting surface 41. As a result, the acoustic sensor 100 can accurately detect sound vibrations generated near the tire TR.

Further, the sensor support 61 of the first embodiment is held on the cover outer surface 23 of the front portion 26 of the cover body 21 that is located forward of the tire TR in the forward direction Ze of the vehicle Ve. Thus, the acoustic sensor 100 can effectively acquire the pushing sound of the tire TR pushing out water accumulated on the road surface. As a result, the accuracy of estimating the water level on the road surface can be improved.

In the above embodiment, the wheel well cover 20 corresponds to “a cover member”, the cover body 21 corresponds to “a curved plate portion”, the sound collecting surface 41 corresponds to “a facing surface”, and the sound vibration sensor 51 corresponds to “a vibration detector”.

(Second Embodiment) A second embodiment of the present disclosure shown in FIG. 6 is a modification of the first embodiment. In a vehicle structure 210 of the second embodiment, the acoustic sensor 100 is invisibly placed rearward of the tire TR. The cover body 21 has a rear portion 27, and the sensor support 61 of the acoustic sensor 100 is attached to the cover outer surface 23 of the rear portion 27. The rear portion 27 is a portion of the cover body 21 that is located rearward of the tire TR in the reverse direction of the vehicle Ve. The rear portion 27 is a region of the cover body 21 located rearward of the rear end TBe of the tread surface of the tire TR. The cover outer surface 23 of the rear portion may be fitted with a guide used for positioning the acoustic sensor 100.

In the vehicle structure 210 according to the second embodiment described above, the acoustic sensor 100 can also effectively collect sound vibrations generated near the tire TR by using the cover body 21 that covers the tire TR. Thus, the second embodiment also has the same effects as those in the first embodiment, and the detection accuracy of sound vibrations generated near the tire TR can be improved.

In addition, the sensor support 61 of the second embodiment is held on the cover outer surface 23 of the rear portion 27 of the cover body 21 that is located rearward of the tire TR in the reverse direction of the vehicle Ve. Thus, the acoustic sensor 100 can effectively capture the sound vibrations caused by the tire TR stirring up water accumulated on the road surface. As a result, it becomes possible to accurately determine whether the road surface on which the vehicle is traveling is wet and to accurately estimate the water level on the road surface that is below the predetermined value.

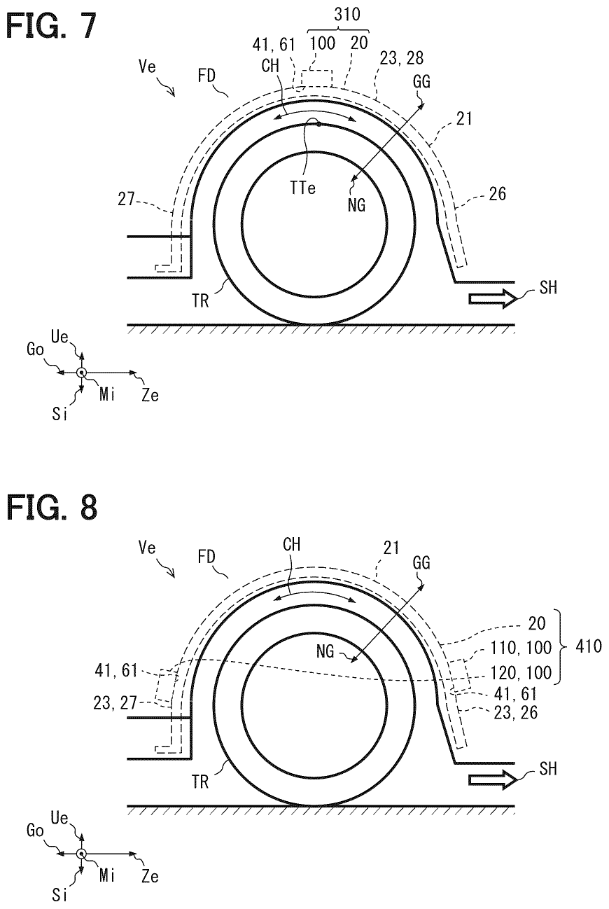

(Third Embodiment) The third embodiment of the present disclosure shown in FIG. 7 is another modification of the first embodiment. In a vehicle structure 310 of the third embodiment, the acoustic sensor 100 is invisibly disposed in an upper area of the tire TR. The cover body 21 has a central top portion 28, and the sensor support 61 of the acoustic sensor 100 is attached to the cover outer surface 23 of the central top portion 28. The central top portion 28 is located upward of the tire TR in the up direction UP of the vehicle Ve. The central top portion 28 is a region of the cover body 21 that is located above the upper end TTe of the tread surface of the tire TR. The cover outer surface 23 of the central top portion 28 may be fitted with a guide used for positioning the acoustic sensor 100.

In the vehicle structure 310 according to the third embodiment described above, the acoustic sensor 100 can also effectively collect sound vibrations generated near the tire TR by utilizing the cover body 21. Thus, in the third embodiment, the same effects as those in the first embodiment can be achieved, and the detection accuracy of sound vibrations generated near the tire TR can be improved.

In addition, the sensor support 61 of the third embodiment is held on the cover outer surface 23 of the central top portion 28 of the cover body 21 that is located upward of the tire TR in the up direction Ue of the vehicle Ve. Thus, the acoustic sensor 100 can capture sound vibrations including splashing sounds and pushing sounds through measurement. As a result, it is possible to determine whether the road surface on which the vehicle is traveling is wet and to estimate the water level on the road surface with a relatively high degree of accuracy. Furthermore, even the vehicle Ve has the configuration in which the acoustic sensor 100 cannot be placed inside the front portion 26 and the rear portion 27, it is possible to place the acoustic sensor 100 inside the wheel well cover 20 if space can be secured above the central top portion 28. In the third embodiment, the central top portion 28 corresponds to “an upper portion”.

(Fourth Embodiment) A fourth embodiment of the present disclosure shown in FIG. 8 is still another modification of the first embodiment. The vehicle structure 410 of the fourth embodiment includes multiple (e.g., two) acoustic sensors 100 in addition to the wheel well cover 20. The vehicle structure 410 includes at least a first acoustic sensor 110 and a second acoustic sensor 120 as the multiple acoustic sensors 100.

The first acoustic sensor 110 is invisibly placed forward of the tire TR. The sensor support 61 of the first acoustic sensor 110 is attached to the cover outer surface 23 of the front portion 26 of the cover body 21. The second acoustic sensor 120 is invisibly placed rearward of the tire TR. The sensor support 61 of the second acoustic sensor 120 is attached to the cover outer surface 23 of the rear portion 27 of the cover body 21.

The first acoustic sensor 110 and the second acoustic sensor 120 may be installed at approximately the same height in the vertical direction, or may be installed at different heights. For example, the first acoustic sensor 110 may be installed at a higher position than the second acoustic sensor 120, or may be installed at a lower position than the second acoustic sensor 120. Furthermore, the first acoustic sensor 110 and the second acoustic sensor 120 may be aligned without any left-right offset in the width direction, or may be offset in the width direction.

In the vehicle structure 410 according to the fourth embodiment described above, the two acoustic sensors 100 can effectively collect sound vibrations generated near the tire TR by using the cover body 21. Thus, in the fourth embodiment, the same effects as those in the first embodiment can be achieved, and the detection accuracy of sound vibrations generated near the tire TR can be improved.

In addition, the vehicle structure 410 of the fourth embodiment includes at least the first acoustic sensor 110 and the second acoustic sensor 120 as the multiple acoustic sensors 100. The sensor support 61 of the first acoustic sensor 110 is held on the cover outer surface 23 of the front portion 26 of the cover body 21 that is located forward of the tire TR in the forward direction Ze of the vehicle Ve. On the other hand, the sensor support 61 of the second acoustic sensor 120 is held on the cover outer surface 23 of the rear portion 27 of the cover body 21 that is located rearward of the tire TR in the reverse direction Go of the vehicle Ve. This configuration allows the first acoustic sensor 110 and the second acoustic sensor 120 to capture sound vibrations generated different positions near the tire TR. Thus, by combining the detection signals (i.e., audio data) of the first acoustic sensor 110 and the second acoustic sensor 120, the water volume can be determined more precisely.

(Other embodiments) Although the plurality of embodiments according to the present disclosure has been described above, the present disclosure is not construed as being limited to the above embodiments, and can be applied to various embodiments and combinations within the scope of the gist of the present disclosure.

The mounting position of the acoustic sensor 100 in the width direction of the vehicle Ve may be changed as appropriate. For example, in the first modification of the above embodiment, the acoustic sensor 100 is attached to a position shifted outward from the center of the cover body 21 in the right-left direction. In the first modification, the acoustic sensor 100 is located away from the power source and the vehicle cabin. As a result, noises generated in the vehicle Ve, such as noises generated by the power source and inside the vehicle cabin, are less likely to be included in the detection signals acquired by the acoustic sensor 100.

In the second modification of the above embodiment, the acoustic sensor 100 is attached to the center portion of the cover body 21 in the width direction. In other words, the acoustic sensor 100 is located at a position facing the central portion of the tread surface of the tire TR in the width direction. In the second modification, the acoustic sensor 100 is located at a position where the acoustic sensor 100 is likely to be hit by water splashed up by the tire TR and where it is easy to measure the splashing sounds and the pushing sounds.

Furthermore, the mounting position of the acoustic sensor 100 in the vertical direction of the vehicle Ve may be changed as appropriate. The acoustic sensor 100 may be located upward of the wheel center of the tire TR, or downward of the wheel center in an empty state of the vehicle Ve.

In the third modification of the above embodiment, the acoustic sensor 100 is located near one of the left and right rear tires of the vehicle Ve. In the fourth modification of the above embodiment, the acoustic sensor 100 is provided near each of the left rear tire and the right rear tire. Furthermore, in the fifth modification of the above embodiment, the acoustic sensors 100 are provided in the vicinity of all the tires TR. As in the above-described third to fifth modifications, the number and positions of the acoustic sensors 100 may be changed as appropriate.

The vehicle structure according to the sixth modification of the fourth embodiment is provided with three acoustic sensors 100. The vehicle structure includes the first acoustic sensor 110 provided in the front portion 26, the second acoustic sensor 120 provided in the rear portion 27, and the third acoustic sensor provided in the central top portion 28.

In the seventh modification of the fourth embodiment, the first acoustic sensor 110 and the second acoustic sensor 120 are both attached to the cover outer surface 23 of the front portion 26. The first acoustic sensor 110 and the second acoustic sensor 120 are disposed at positions shifted from each other in at least one of the circumferential direction CH and the axial direction of the tire TR. As in the seventh modified example, the arrangement of the multiple acoustic sensors 100 attached to one wheel well cover 20 may be changed as appropriate.

In the eighth modification of the above embodiment, the sound collecting surface 41 faces the cover outer surface 23 without contacting the cover outer surface 23 when the sensor support 61 is held on the cover outer surface 23. A space is defined between the sound collecting surface 41 and the cover outer surface 23. As in the eighth modification, the sound collecting surface 41 may not be in contact with the cover outer surface 23 if the sound collecting surface 41 can collect sound vibrations of the cover body 21.

In the ninth modification of the above embodiment, a single acoustic sensor 100 has multiple (e.g., two) sound vibration sensors 51 built therein. According to the acoustic sensor 100 of the ninth modified example, the sound vibrations occurring near the tire TR can be detected by using multiple sound vibration sensors 51. Thus, the detection signals (i.e., audio data) of each sound vibration sensor 51 can be collectively used, enabling a more precise determination of the water volume.

The vehicle Ve on which the vehicle structure 10 and the acoustic sensor 100 are mounted is not limited to a typical private four-wheeled passenger vehicle. The vehicle structure 10 and the acoustic sensor 100 may be mounted on various vehicles, such as motorcycles, unmanned vehicles for mobility services, construction vehicles, agricultural vehicles, rail vehicles, trams, and DMVs (Dual Mode Vehicles) to recognize audio data. In addition, the number and positions of the acoustic sensors 100 may be optimized as appropriate depending on the type of the vehicle Ve, the purpose of the vehicle Ve, and the traffic environment and regulations of the country or region in which the vehicle Ve is used.

1. An acoustic sensor configured to be attached to a cover member covering an outer circumferential portion of a tire of a vehicle and configured to measure information related to sound vibrations, the acoustic sensor comprising:
a sensor support configured to be attached to a cover outer surface of the cover member, the cover member having a curved plate portion extending in a circumferential direction of the tire, the cover outer surface being one surface of the curved plate portion that faces away from the tire;
a facing surface configured to face the cover outer surface to receive the sound vibrations of the cover outer surface when the sensor support is attached to the cover outer surface; and
a vibration detector configured to detect the sound vibrations that are received by the facing surface.

2. The acoustic sensor according to claim 1, wherein
the facing surface is directly or indirectly in contact with the cover outer surface when the sensor support is attached to the cover outer surface.

3. A vehicle structure comprising:
a cover member having a curved plate portion extending in a circumferential direction of a tire of a vehicle and configured to cover an outer circumferential portion of the tire; and
an acoustic sensor attached to the cover member and configured to measure information related to sound vibrations, wherein
the acoustic sensor includes:
a sensor support attached to a cover outer surface that is one surface of the curved plate portion facing away from the tire;
a facing surface facing the cover outer surface to receive the sound vibrations of the cover outer surface when the sensor support is attached to the cover outer surface; and
a vibration detector configured to detect the sound vibrations that are received by the facing surface.

4. The vehicle structure according to claim 3, wherein
the curved plate portion has a front portion that is located forward of the tire in a forward direction of the vehicle, and
the sensor support is attached to the cover outer surface of the front portion.

5. The vehicle structure according to claim 3, wherein
the curved plate portion has a rear portion that is located rearward of the tire in a reverse direction of the vehicle, and
the sensor support is attached to the cover outer surface of the rear portion.

6. The vehicle structure according to claim 3, wherein
the curved plate portion has an upper portion that is located upward of the tire in an up direction of the vehicle, and
the sensor support is attached to the cover outer surface of the upper portion.

7. The vehicle structure according to claim 3, wherein
the acoustic sensor is one of acoustic sensors,
the acoustic sensors include a first acoustic sensor and a second acoustic sensor,
the curved plate portion has a front portion that is located forward of the tire in a forward direction of the vehicle and a rear portion that is located rearward of the tire in a reverse direction of the vehicle,
the sensor support of the first acoustic sensor is attached to the cover outer surface of the front portion, and
the sensor support of the second acoustic sensor is attached to the cover outer surface of the rear portion.
